(19) United States
(12) Patent Application Publication
(10) Pub. No.: US 2014/0061142 A1
(43) Pub. Date: Mar. 6, 2014

(54) Filter Plate And Process For Filtering A Suspension

(71) Applicant: Andritz Technology and Asset Management GmbH, (US)

(72) Inventors: Heinz BONN, Kreuzau-Winden (DE); Peter OHORN, Staig (DE)

(73) Assignee: ANDRITZ TECHNOLOGY AND ASSET MANAGEMENT GMBH, Austria (AT)

(21) Appl. No.: 13/776,050

(22) Filed: Feb. 25, 2013

(30) Foreign Application Priority Data
Feb. 27, 2012 (AT) A 244/2012

(51) Int. Cl. B01D 25/38

(52) U.S. Cl. CPC B01D 25/38
USPC 210/791; 210/231; 210/767

(57) ABSTRACT

A filter plate (1) with at least one filling shoe (2, 2′) having a drive (4, 7, 18). A process for filtering a suspension, which is fed through at least one filling shoe (2, 2′) into at least one filter chamber formed between a filter plate and a counterplate of a filter device, where a filter cake forms on a filter cloth (8) on the filter plate (1), where the filter device is opened, and where the at least one filling shoe (2, 2′) is lifted subsequently off the filter cloth (8) by means of the drive (4, 7, 18) and the filter cloth (8) is conveyed onwards. By using a drive to move the filling shoe, the time at which the filling shoe is lifted off the filter cloth can be selected such that the filling shoe suffers no damage and the filter cloth conveyed further onwards.

### BACKGROUND

The invention relates to a filter plate with at least one filling shoe and a filter device with several filter plates, as well as to a process for filtering a suspension that is fed through at least one filling shoe into at least one filter chamber formed between a filter plate and a counterplate of a filter device, where a filter cake forms on a filter cloth on the filter plate.

Devices and processes of this kind are known, for example from DE 10 2007 027 032 B3. When the filter device is opened, the filling shoes are lifted off the filter plate there by elastic seals which act as springs, unclamping the filter cloth as they do so. As a result of the filling shoes being lifted during opening, there is a risk that some of the filter cake may fall onto the filling shoe and damage it. In addition, parts of the filter cake may land on areas of the filter cloth that are then to be sealed off and thus cause leaks. Furthermore, the filter cloth may suffer cracks by being clamped frequently in the same place.

The invention should, therefore, create a filter plate and a filter device that offers reliability and trouble-free operation.

### SUMMARY

The invention is thus characterized by the filling shoe having a drive. With a drive, the filling shoe can be lifted off the filter plate at any desired time, which means that it can also be lifted when the filter chamber has been completely emptied and the filter cake has been fully removed from the filter cloth as far as possible, thus preventing damage to the filling shoe by the filter cake. In addition, the filling shoe does not have to be lifted at every filtration cycle, which reduces the strain on the filter cloth at the clamping point and thus results in a longer filter cloth service life.

An advantageous development of the invention is characterised by the drive being designed as an actuating motor or actuating cylinder.

A favourable embodiment of the invention is characterised by the drive being designed as a mechanical lever.

A favourable development of the invention is characterised by several filter plates being provided with levers, where the filter plate levers are connected to one another with a cable pull, a chain, or a device with the same function.

An advantageous embodiment of the invention is characterised by one end of the cable pull or chain being connected to a pulling device, where the pulling device is preferably a cylinder with working fluid, for example a pneumatic or hydraulic cylinder.

The invention also relates to a process for filtering a suspension, which is fed through at least one filling shoe into at least one filter chamber formed between a filter plate and a counterplate of a filter device, where a filter cake forms on a filter cloth on the filter plate. It is characterised by the filter device being opened, where the at least one filling shoe is lifted subsequently off the filter cloth by means of a drive and the filter cloth is conveyed onwards.

A favourable development of the invention is characterised by the filter device being pulled completely apart and emptied, and the filling shoes then being lifted off the filter cloth all together by means of a pulling device, where the load on the pulling device should preferably be relieved as soon as the cloth movement comes to an end.

An advantageous development of the invention is characterised by the filling shoes being guided towards the filter cloth, for example by means of a mechanical force such as a spring, cylinder or actuating motor, before the filter device is closed.

A favourable embodiment of the invention is characterised by the filling shoes being pressed into depressions by the closing filter elements and thus clamping the filter cloth.

### BRIEF DESCRIPTION OF THE DRAWING

The invention is now described in the following examples with references to the figures, where:

FIG. 1 a shows a section of a filter plate according to a variant of the invention,

FIG. 1 b shows the filling shoe guide element according to a variant of the invention,

FIG. 2a shows a section of a filter plate according to another variant of the invention,

FIG. 2b shows the same section as FIG. 2a with the filling shoe lifted,

FIG. 3 shows an arrangement of several filling shoes in a filter device according to the invention,

FIG. 4 shows a schematic diagram of the connection between the levers of several filling shoes,

FIG. 5a shows another variant of the invention,

FIG. 5b shows the guide element of the filling shoe according to the other variant of the invention,

FIG. 6 shows a filter plate with filling shoe according to the invention, and

FIG. 7 shows a schematic diagram of the filter plate arrangement in a filter press device according to the invention.

### DETAILED DESCRIPTION

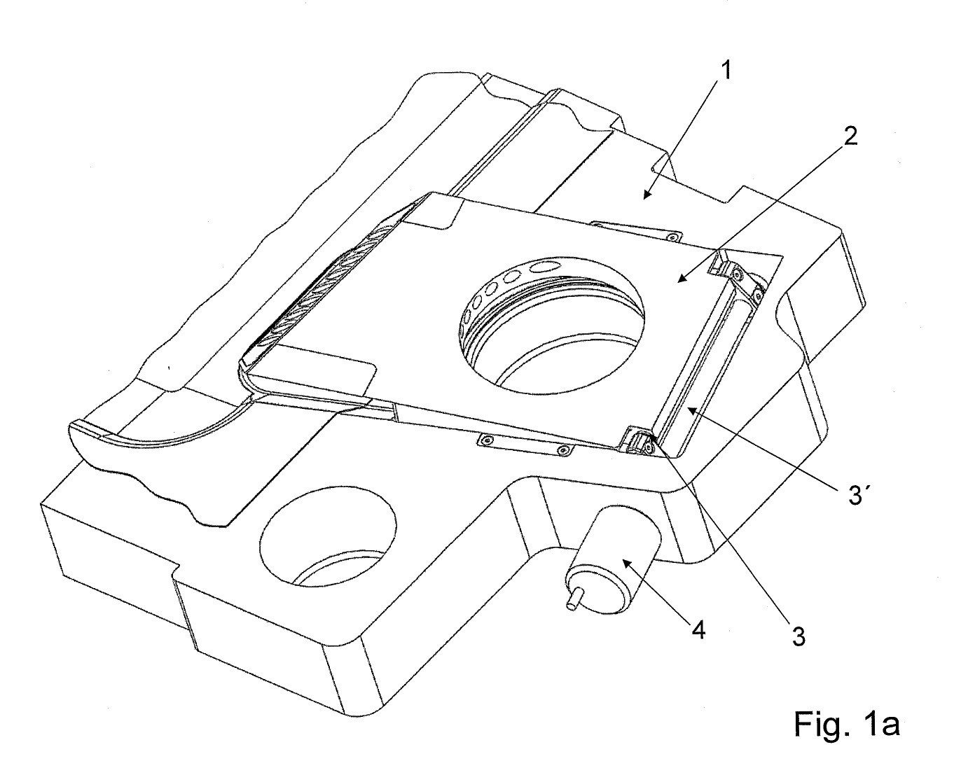

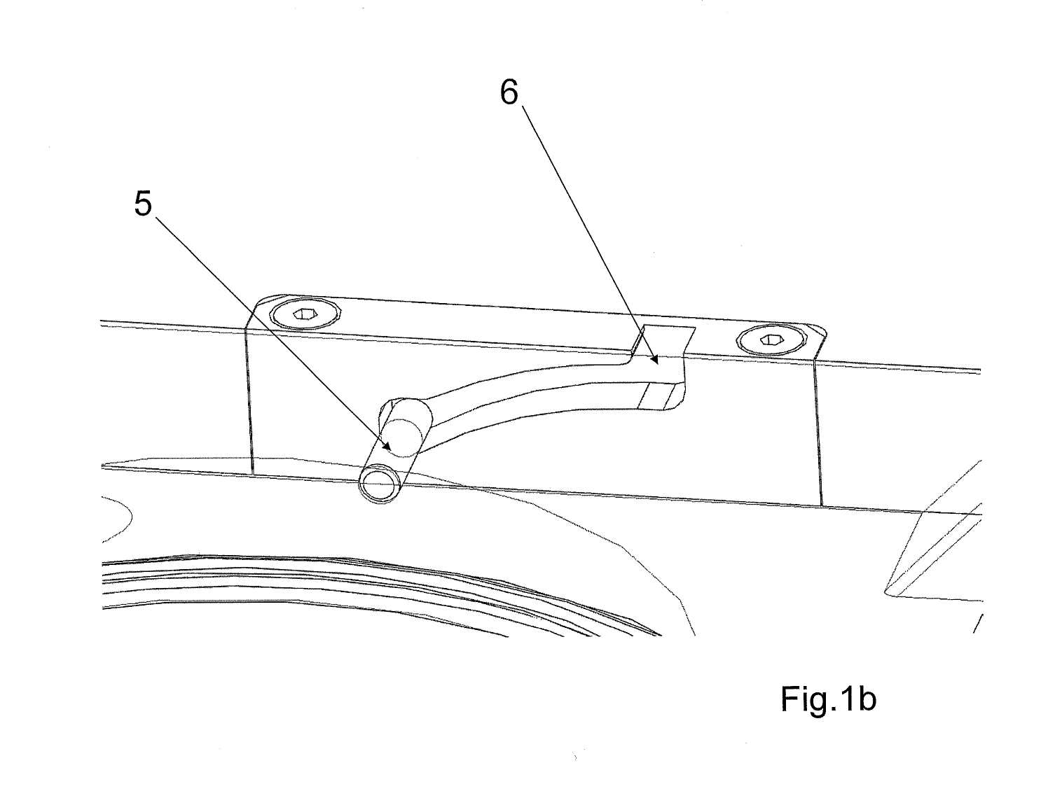

FIG. 1a shows a section of a filter plate 1 with a filling shoe 2, through which suspension enters a filter chamber during operation. The filling shoe 2 can be pivoted round an axis 3. The pivoting movement is effected by means of an actuating motor 4 via the shaft 3′ such that the filling shoe 2 is lifted off the filter plate 1. In order to avoid tilting, a pin 5 is guided in a sliding block 6 (FIG. 1 b), which causes the filling shoe 2 in practice to be moved first of all and then lifted out in parallel. Electric actuating motors, electrical or pneumatic stepping motors, or swivel motors are used here as actuating motors 4. The motors for the individual filling shoe drives are then activated so that they lift the filling shoes 2 off the filter plates 1 after the filter device has been opened completely, i.e. when the filter plates 1 have moved fully apart.

With further reference to FIGS. 1a and 1b, it should be understood that the filling shoe 2 has a pair of inserts 20 including respective sliding blocks 6, each guiding a slide pin 5. The filling shoe 2 is opened by pivoting around axis 3 and at the same time around shaft 3′. Together with the pins 5 and sliding blocks 6, the shoe 2 is lifted substantially parallel from the plate 1 to first release the cloth 8 and then pivot off plate 1 until a certain angle is reached.

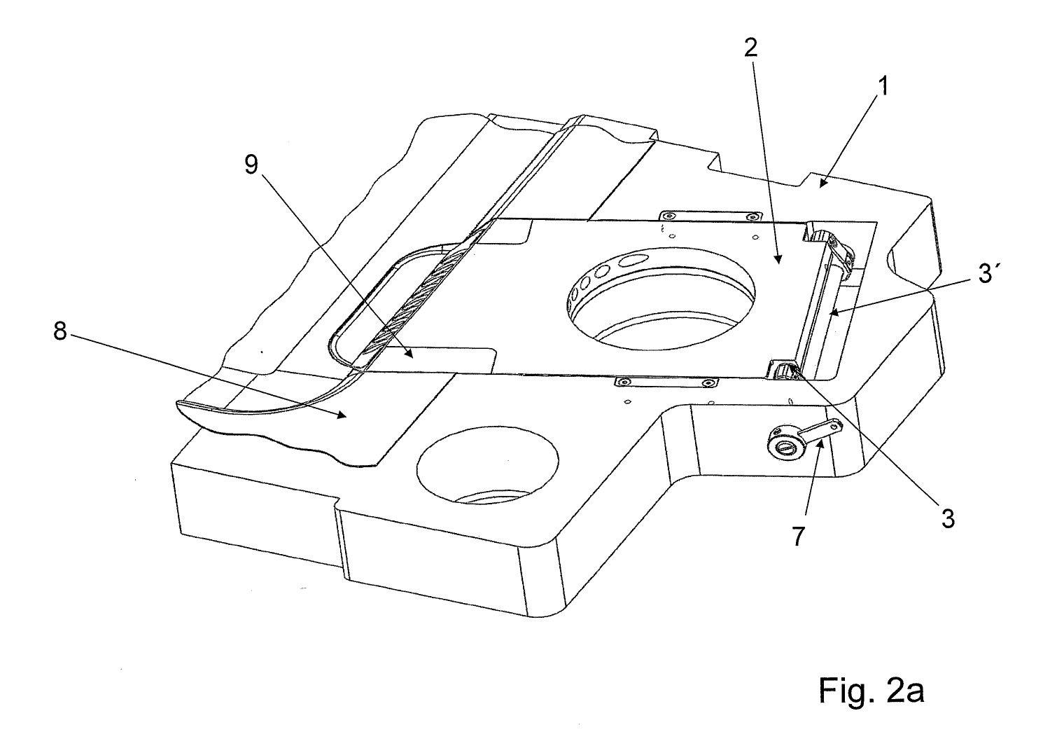

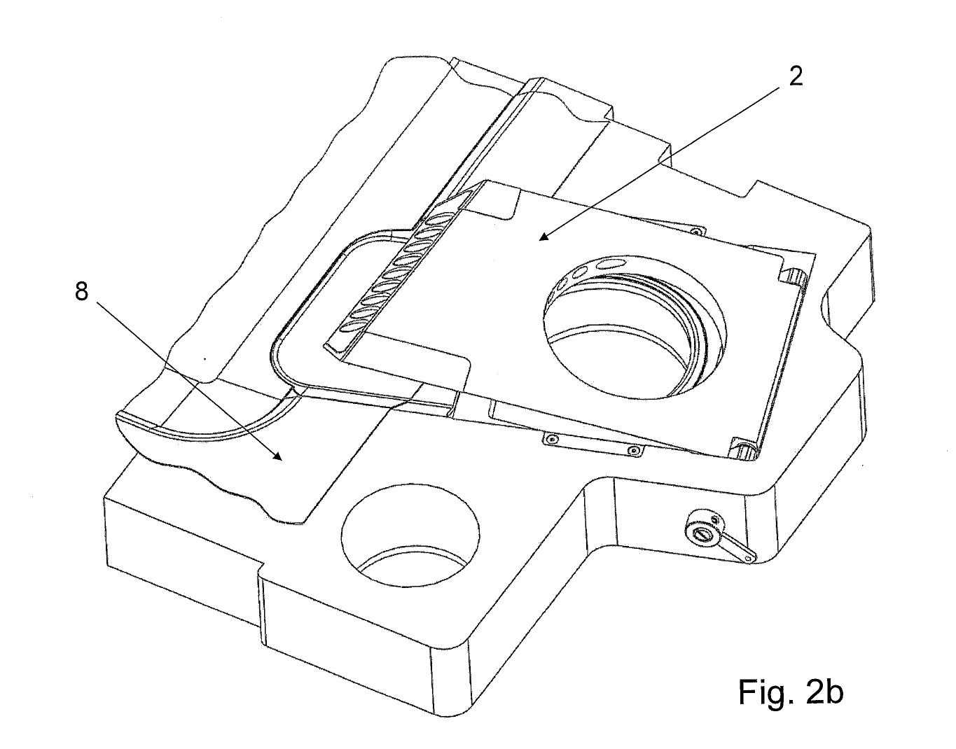

FIG. 2a shows an alternative variant of a drive for a filling shoe 2. Once again, a section of a filter plate (filter element) 1 is shown in which a filling shoe 2 can turn or pivot round an axis 3. The filling shoe 2 is lifted off the filter plate 1 via the shaft 3′ by means of a lever 7, where a pin 5 is guided in a sliding block 6 (in the same way as in FIG. 1 b). A section of the filter cloth 8 is visible here, which is clamped by the filling shoe 2 in the area where there are appropriate seals 9 in the filter plate 1.

FIG. 2b shows the variant described in FIG. 2a with the filling shoe open, i.e. the filling shoe 2 lifted. In this position, the filter cloth 8 can be changed or transported onwards easily. In FIG. 2b, it can be seen that the filling shoes are pressed into depressions 21 by the closing filter plates 1, thereby clamping the filter cloth 8.

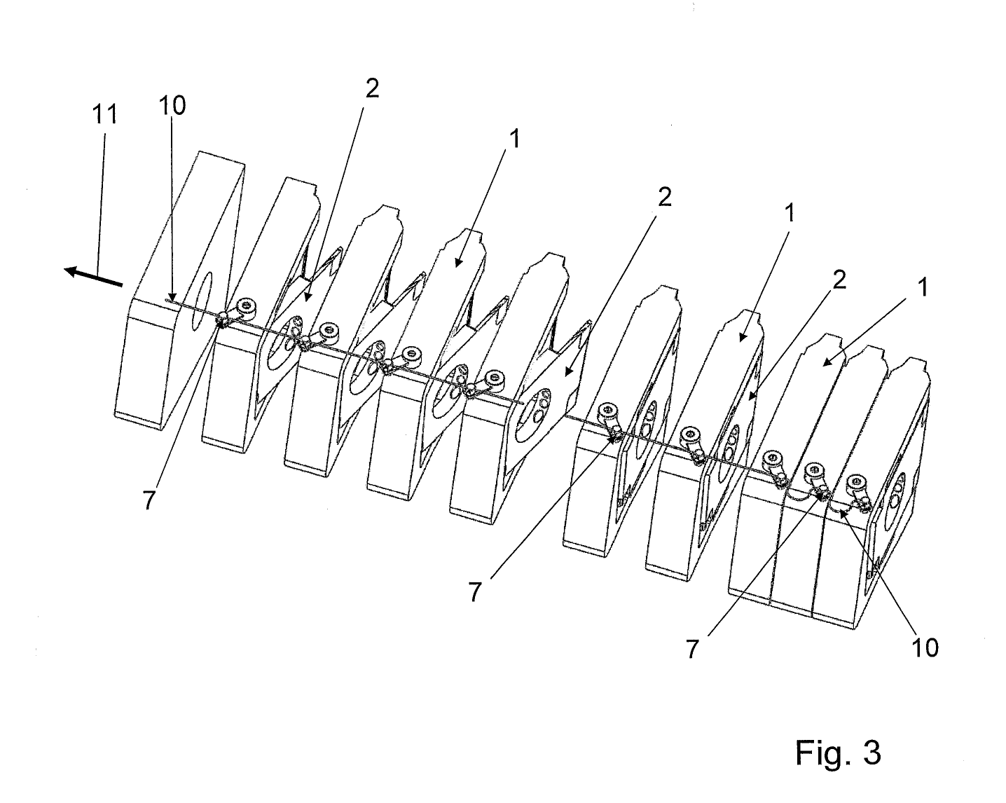

FIG. 3 shows the arrangement of several filling shoes 2 that can be pivoted in filter plates 1 (here only showing the part in which the filling shoe is mounted). Here, once again, levers 7 are shown as the drive, connected by a cable pull 10 for example. A chain or a device with the same function can also be used in place of a cable pull 10. The cable pull 10 or the chain is so long that the levers 7 at the intermediate elements are not moved when the filter device is opened. When the filter device, e.g. a filter press, has been fully opened, the cable pull 10 is tensioned slightly. A pulling tool at the end of the cable pull 10 or chain is then moved in the direction of the arrow 11, which also causes all levers 7 to be moved simultaneously, thus lifting all filling shoes 2 away from the corresponding filter plates 1 also practically simultaneously. The various positions of the filter plates 1 are shown in FIG. 3. The closed status is shown on the right-hand side (three elements), for example, where the cable pull 10 or chain sags. The next elements show the status shortly after opening the filter device, i.e. the tension pull 10 is tensioned slightly and the filling shoes 2 are still in the filter plate 1. The four left-hand filter plates 1 show the status after the cable pull 10 has been actuated. This is also evident from the position of the levers 7. The vertical arrangement of the filter plates 1 is also clearly visible here. In principle, however, the filter plates 1 can also be arranged horizontally.

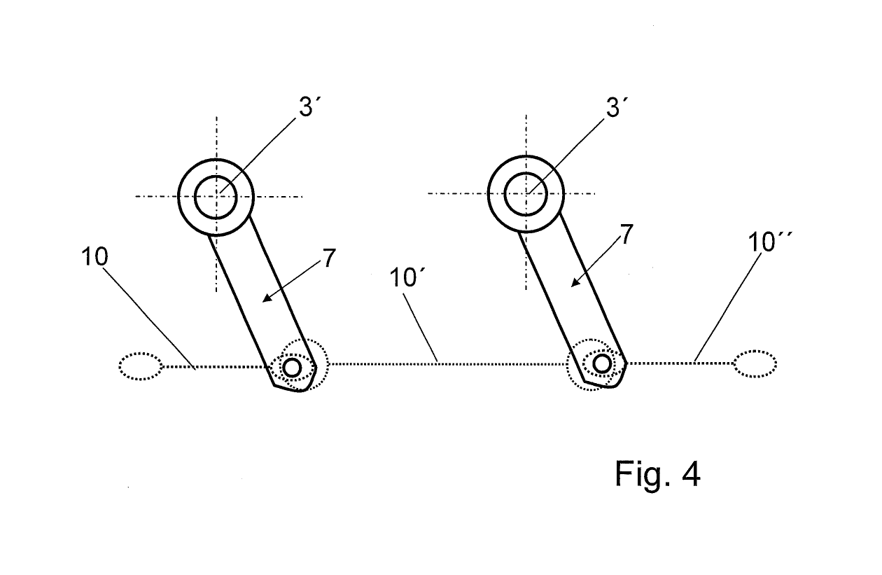

FIG. 4 illustrates the arrangement of the connection between the individual levers 7 of two filter plates. Here, the levers are connected to the shafts 3′. The levers 7 are connected to one another by a cable pull 10, where this can also be made up of segments 10, 10′, 10″. The advantage of this would be that each filter plate has a pulling cable segment 10, 10′, 10″ and can thus also be replaced individually. The structure of the pulling cable 10 in segments would also offer the advantage of segment 10, 10′, 10″ being easy to replace if it breaks. Alternatively, a segment of this kind in a chain could consist of three chain links, for example, so that the chain is not tensioned slightly here either until after the filter device (filter press) has been opened and this chain is then fully tensioned by a tensioning element, with the result that the levers 7 are moved and the filling shoes 2 are lifted off the filter plate 1 and the filter cloth 8.

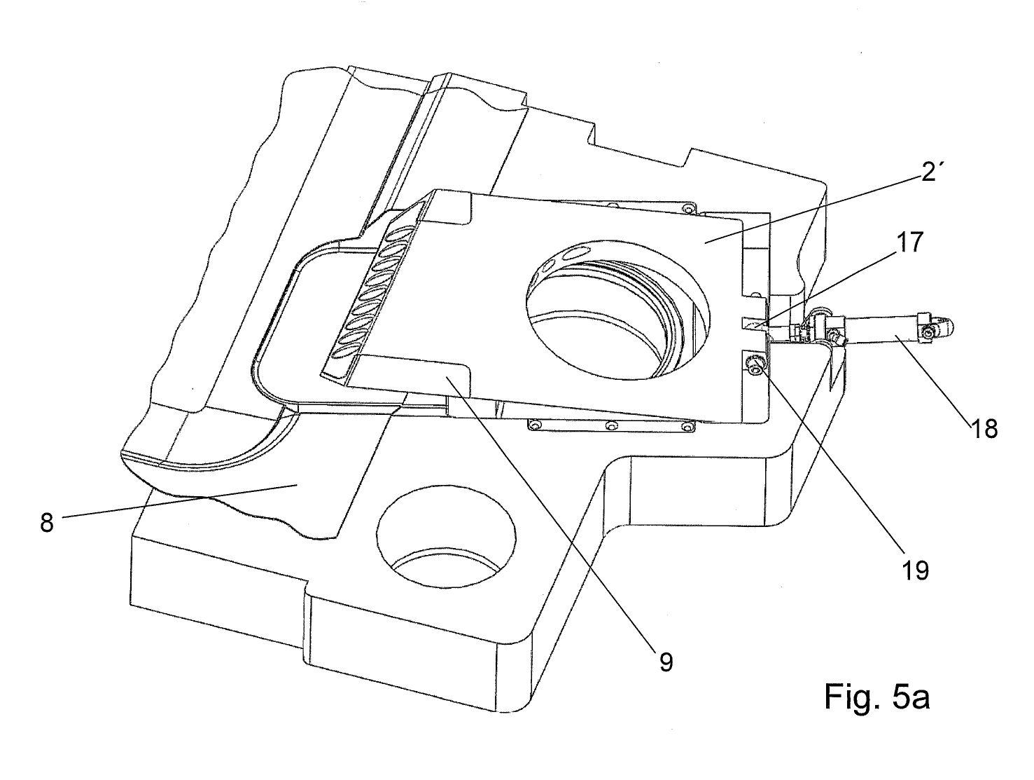

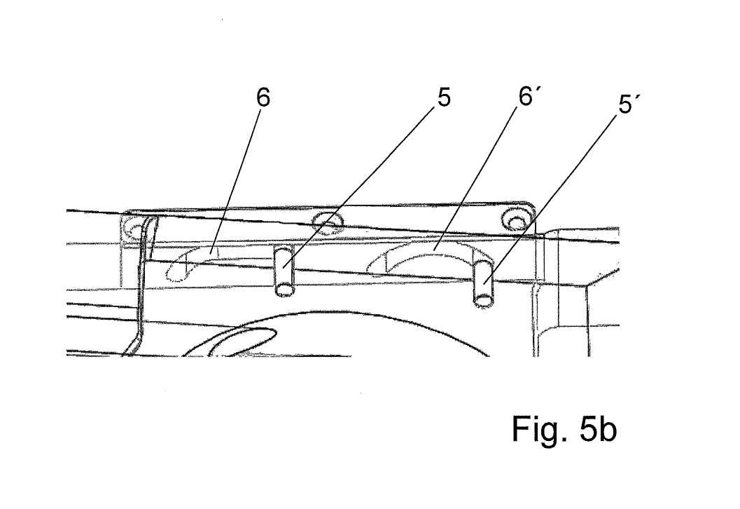

FIG. 5a shows another variant of the invention. The illustration shows a filter plate 1 with a filling shoe 2′, which is lifted off the filter cloth 8 in the same way as in FIG. 2b. Here, the filling shoe 2′ is connected via a rod end 17 to a double-acting lifting cylinder 18, which is connected to the filter plate 1 via a swivel mounting 19. When the piston rod of the lifting cylinder 18 runs out, it pushes the filling shoe 2′ forwards. When the piston rod runs in, it pulls the filling shoe 2′ back. FIG. 5b shows the movement of the filling shoe 2′, which is determined by pins 5, 5′ in the sliding blocks 6, 6′. As a result, the filling shoe 2′ lifts off the filter cloth 8 when pulled back. The advantage of this variant is that no axles, levers or springs are needed here and the design is thus much simpler. In addition, there are advantages in holding the filing shoe 2′ in the depression with the preferably pneumatic force of the lifting cylinder 18. Of course, a hydraulic cylinder can also be used.

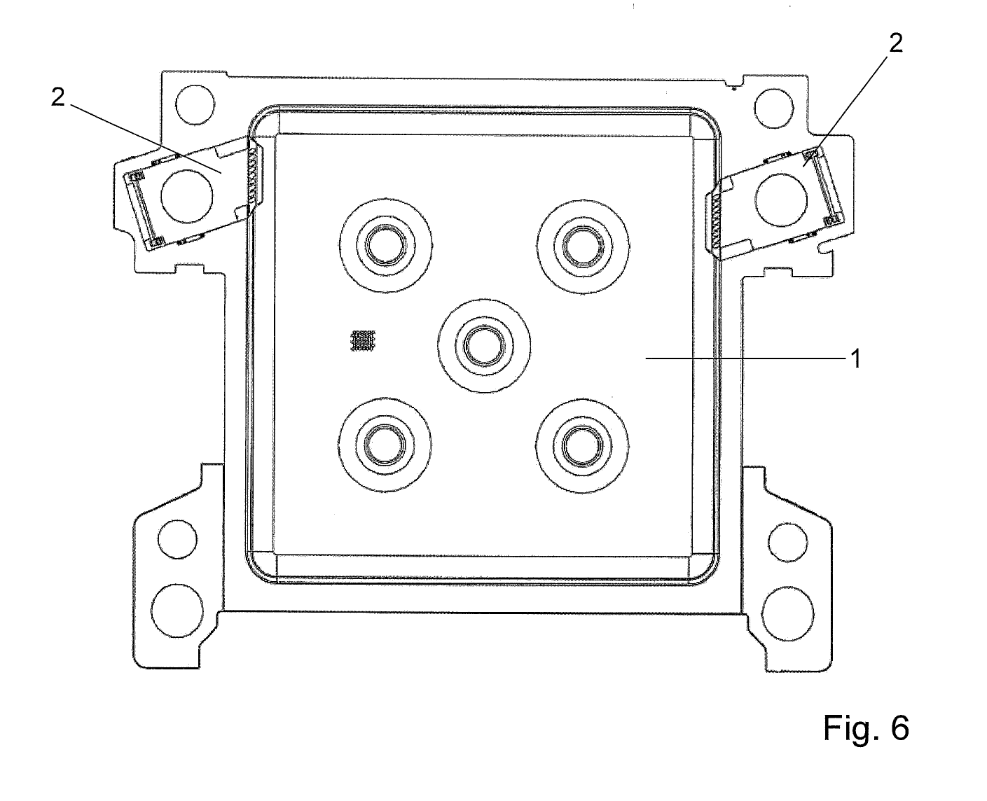

FIG. 6 shows an example of a filter plate 1, which has two filling shoes 2 here. Of course, the filter plate 1 can also have a different configuration with only one filling shoe 2 or also several filling shoes 2 depending on requirements and possibly the size of the filter plate 1.

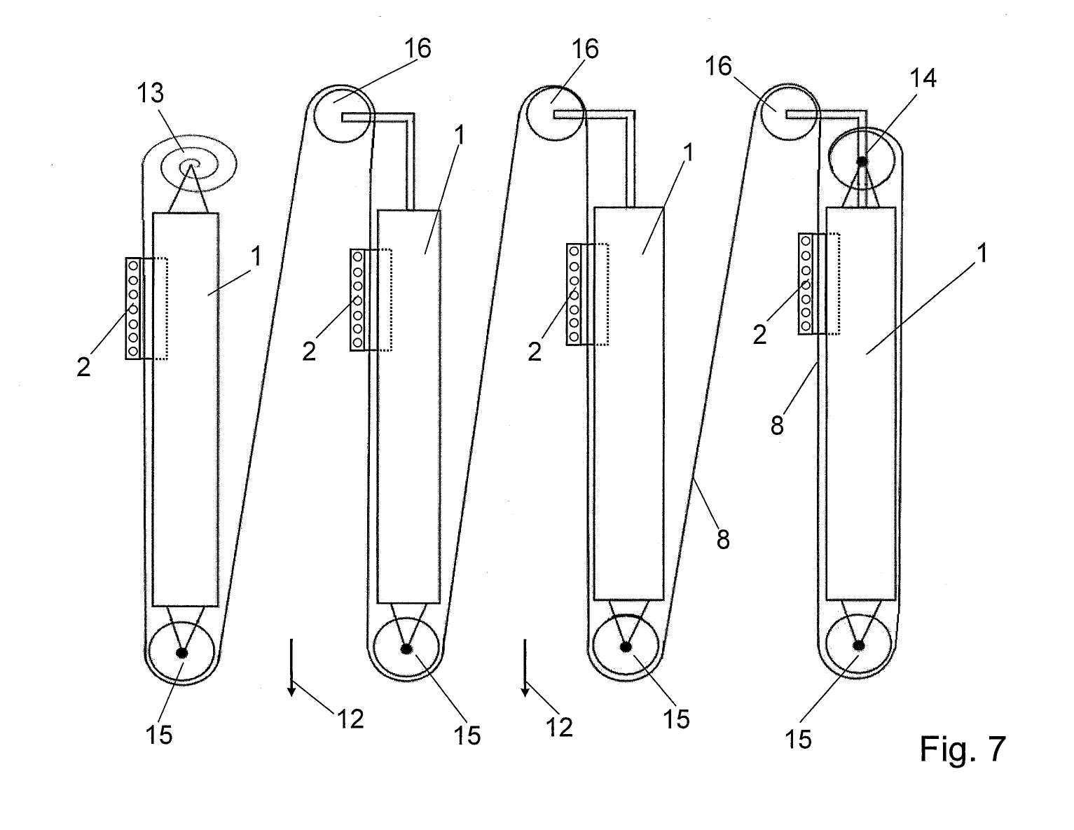

FIG. 7 shows a filter device with several filter plates 1 (a stack of filter plates) with filling shoes 2 in them. On the filter plates 1 there is a filter cloth 8, which has a seamless design in the present example, i.e. it runs over several filter plates 1. When the filter device has been opened, i.e. when the filter plates 1 have moved apart, the filter cake 12 drops out of the filter device. As the filling shoes 2 are still embedded in the filter plates 1 during this process, they cannot suffer any damage either. Depending on the products to be filtered, the filter cloth 8 can remain in position or, alternately, the filling shoes 2 can be lifted off and the filter cloth 8 moved further on, for example by one filter plate length. Here it is unrolled from a roll 13 and rolled up onto a roll 14. It is deflected by deflection rolls 15 located at the lower end of the filter plates and by deflection rolls 16 arranged at the upper end of the filter plates. In order to clean the filter cloth, the lower deflection rolls 15, for example, can be provided with holes and a connection for washing liquid. If the filter cloth 8 has been wound fully onto the roll 14 after several transport cycles, the transport direction is reversed, and the cloth is unwound from the roll 14 and wound onto the roll 13. FIG. 7 shows four filter plates which together form a filter plate stack. A filter device largely consists of a number of such filter plate stacks. The length of the filter cloth 8 depends on the number of filter plates per filter plate stack.

As shown in FIGS. 6 and 7, the filter plates 1 can move on a frame with projections or hooks engaging grooves 23, and for filtering are pressed together such as by hydraulic cylinders. Each space 22 between respective plates 1 is thereby constricted for defining a narrow filter chamber where the suspension is pressed against the cloth. The resulting filter cakes 12 are removed by dropping out as the plates are moved away from each other to re-open the space between the plates.

The invention is not limited to the examples. For example, the orientation of the filter plates can be horizontal. The only essential criterion is that the filling shoe or the filling shoes are not lifted off the filter cloth until the filter plates have been pulled apart. After this the filter cloth can be moved. By using a drive to move the filling shoe, the time at which the filling shoe is lifted off the filter cloth can be selected such that the filling shoe suffers no damage, and the filter cloth clamping can also be opened after two or more filtration cycles and the filter cloth conveyed further onwards if this is possible with the products to be filtered.

1. A filter plate for a filter press, comprising a filling shoe and a drive for lifting the filling shoe off the filter plate.

2. The filter plate of claim 1, wherein the drive includes one of an actuating motor or actuating cylinder.

3. The filter plate of claim 1, wherein the drive includes a mechanical lever.

4. The filter plate of claim 2, wherein a plurality of filter plates have a respective plurality of said filling shoes, each shoe operated by a drive.

5. The filter plate of claim 4, wherein all said filling shoes are driven.

6. A filter press comprising a plurality of filter plates and a respective plurality of fillings shoes, wherein each filling shoe has a drive for operating the filling shoe between lifted and closed positions.

7. The filter press of claim 4, wherein said drive comprises a lever on each said filter plate and means for actuating all said levers to operate said filling shoes.

8. The filter press of claim 7, wherein said means for actuating comprises one of a cable or chain connected to each of said levers.

9. The filter press of claim 8, wherein said cable or chain has one end that is selectively pulled by an actuating cylinder having a working fluid.

10. A process for filtering a suspension, comprising:
with a filling shoe holding a filter cloth on a filter plate, feeding the suspension through the filing shoe into a filter chamber formed between the filter plate and a closely confronting counterplate;
forming a filter cake on the cloth between the plate and the closely confronting counterplate;
separating the plate from the counterplate;
operating the filling shoe with a drive to lift the filling shoe from the filter cloth; and
while the filling shoe is lifted, moving the cloth relative to the filter plate.

11. The process of claim 10, wherein
the filter press comprises a plurality of filter plates and a respective plurality of fillings shoes, counterplates and filter chambers, wherein each filling shoe has a drive for operating the filling shoe between lifted and closed positions;
one cloth spans all of the plates;
the filter cake is dropped from each filter chamber when the respective plates and counter plates are separated; and
the cloth is moved relative to all the plates while the filling shoes are open and the plates and counterplates are separated.

12. The process of claim 11, wherein
the filling shoes are biased in the closed position;
the drive includes connections to all the filling shoes;
the drive selectively lifts the shoes together by applying a pulling load on said connections;
the cloth is moved an increment while the plates and counterplates are separated; and
the drive closes the filling shoes by relieving said pulling load after the cloth has moved said increment.

13. The process of claim 11, wherein the filling shoes are guided toward the filter cloth by a mechanical force before the filter device is closed.

14. Process according to claim 13, wherein the filling shoes clamp the cloth as the filling shoes are pressed into depressions in the filter plate as the filter plates are closed.
